(19) United States
(12) Patent Application Publication
(10) Pub. No.: US 2017/0234302 A1
(43) Pub. Date: Aug. 17, 2017

(54) INNOVATIVE WIND TURBINE CONSTRUCTION FOR 100% ENERGY INDEPENDENCE OR EVEN BEING ENERGY POSITIVE

(71) Applicant: Hattar Tanin LLC, Novato, CA (US)

(72) Inventors: Saadeh Hattar, Novato, CA (US); Volodymyr Tanin, Kiev (UA)

(21) Appl. No.: 15/361,325

(22) Filed: Nov. 25, 2016

Related U.S. Application Data
(60) Provisional application No. 62/259,834, filed on Nov. 25, 2015.

(51) Int. Cl. F03D 7/06; F03D 13/20; F03D 3/06; F03D 9/25; F03D 3/00; F03D 3/04

(52) U.S. Cl. CPC F03D 7/06; F03D 3/005; F03D 3/0472; F03D 3/062; F03D 9/25; F03D 13/20; F05B 2240/213; F05B 2240/60

(57) ABSTRACT

Systems, methods, and apparatuses are provided for generating clean energy. A Savonius vertical-axis wind turbine, including a shaft configured to rotate about a first axis, aerofoil blades transversely mounted with respect to the first axis, on the shaft, transversely extending outwards from the shaft to a first distance from the shaft, a generator coupled to the shaft, the generator configured to generate electricity from rotational energy of the shaft when the shaft rotates about the axis; and a first curved wind shield having a semi-circular shape defined by a curvature, each point of the curvature is a fixed second transverse distance from the shaft, the first curved wind shield positioned at the fixed second transverse distance from the rotating shaft, and the curved wind shield is rotatable about the rotating shaft, at the fixed second distance. In some embodiments, the wind shields increase productive wind circulation to the turbine blades.

### CROSS REFERENCE TO RELATED APPLICATION

This application claims priority to U.S. Provisional Patent Application No. 62/259,834, entitled “Innovative Wind Turbine Constructions for 100% Energy Independence or Even Being Energy Positive,” filed Nov. 25, 2015, which is hereby incorporated by reference.

### TECHNICAL FIELD

This specification describes wind turbines having higher energy efficiencies.

### BACKGROUND

There are two major classifications of wind turbines, horizontal-axis wind turbines and vertical-axis wind turbines. Horizontal-axis wind turbines generally have blades that extend radially from one or more points on a vertical support that typically does not rotate. The blades rotate about an axis horizontal to the ground. Vertical-axis wind turbines generally have blades that extend radially from one or more points on a vertical support that typically is caused to rotate by the rotation of the blades about an axis vertical to the ground. Further, there are two major subclasses of vertical-axis wind turbines, Savonius-type and Darrieus-type vertical-axis wind turbines.

Because of the vertical orientation of the blades on a vertical-axis wind turbine, wind that provides a productive force against a first face of a blade (e.g., powering the turbine) also provides a counterproductive force against the opposite face of other blades rotating simultaneously. This lowers the overall efficiency of vertical-axis wind turbines, and specifically for Savonius-type vertical-axis wind turbines.

### SUMMARY

The present disclosure solves these and other problems by providing Savonius vertical-axis wind turbines with one or more wind shields that block counterproductive wind forces, also referred to herein as a “parasitic” component of wind. In some embodiments, the wind turbines provided herein also increase power production by directing additional wind to circulate within the space framed by one or more wind shields, thereby applying a greater productive wind force onto the blades of the turbine.

In some embodiments, the disclosure describes vertical axis wind turbines, which are shielded from the parasitic component of wind force with mobile shield(s). Mobile shield(s) is constantly adjustable to the direction of wind stream, including to cover from parasitic component of wind force and/or providing optimal effect of wind stream circulation. In the proposed design the part of the turbine where blades are moving against the wind is shielded. The shield(s) position is adjustable to the wind direction. The turbine may be constructed as a horizontal-axis turbine. The same principle may be used for water turbines as well.

In some aspects, the disclosure describes a vertical axis wind turbine, which is shielded from the parasitic component of wind force with mobile shield. Mobile shield(s) is(are) constantly adjustable to cover from parasitic component of wind force and/or to provide optimal circulation of wind stream in space between shields, allowing wind turbine blades to accept maximum possible energy. The turbine may have one or more blades of any shape and size. Turbine of such construction can be also used as water turbine.

In some embodiments, the turbines described herein are constructed from more than one unit that can be manufactured in the form of multiple construction blocks, which, when turbine is being assembled, can be added/joined by principle of column crane/tower crane and/or alike method of turbine building up from below.

In some embodiments, the turbines described herein are constructed from more than one unit, one on top of another. Each unit has its own moveable shield, providing possibility to be adjusted in the most effective way to accept wind stream force, as streams of wind may have different directions at different height.

In some embodiments, the turbines described herein are equipped with the shield(s) of different size and shape that may have different functions: just shielding; shielding, balancing of the whole construction, redirecting part of wind power to the working part of the turbine; shielding and redirecting the whole wind power to the working part of the turbine; shielding and redirecting of extra wind to the working part of the turbine; and/or making wind-stream circulating.

In some embodiments, the turbines described herein have a directing sail to turn turbine shield into the best position to the wind direction by the force of wind stream, and/or any other mechanism to carry out rotation, including such, which allows to make it in automatic mode.

In some embodiments, the turbines described herein have any form, including but not limited to, cylindrical or coniformic.

In some embodiments, two or more vertical-axis turbines are united together to form a block of turbines (hereinafter also referred to as a “turbine block”) to collect more from wind stream where turbine shield(s) have fixed position and the whole turbine block has to be turned to the wind for adjustment. The turbines of the turbine block may have one or more blades of any shape and size. Turbine block of such construction can be also used in water.

In some embodiments, the turbine blocks described herein are constructed from more than one unit that can be manufactured in the form of multiple construction blocks, which, when turbine block is being assembled, can be added/joined by principle of column crane/tower crane and/or alike method of turbine building up from below.

In some embodiments, the turbine blocks described herein are constructed from more than one unit, one on top of another. Each unit has one or more moveable shield, providing possibility to be adjusted in the most effective way to accept wind stream force, as streams of wind may have different directions at different height.

In some embodiments, the turbines described herein are equipped with the shield(s) of different size and shape that may have different functions: just shielding; shielding, balancing of the whole construction, redirecting part of wind power to the working part of the turbine; shielding and redirecting the whole wind power to the working part of the turbine; shielding and redirecting of extra wind to the working part of the turbine. In some embodiments shields may generate/provide the effect of wind stream circulation in space between shields, where blades are rotating, when blades can accept the maximum possible force of wind stream.

In some embodiments, the turbine blocks described herein have directing sail to turn turbine block and shield(s) into the best position to the wind direction by the force of wind stream and/or any other mechanism to carry out rotation, including such, which allows to make it in automatic mode.

In some embodiments, the turbine blocks described herein have any form (including cylindric, coniform, but any other form(s) is/are also possible).

In some aspects, the disclosure describes horizontal-axis wind turbines using the same principle as the vertical-axis turbines described above. Unlike other horizontal axis turbines this turbine will have maximal capacity/ efficacy when its axis oriented perpendicular to the direction of the wind (this will be like a vertical axis turbine turned by 90°). In this case the shield always covers the part of the turbine where the blades are moving against the wind. The shield may also change its position. The turbine may have one or more blades of any shape and size. Turbine of such construction can be also used as water turbine. In some embodiments turbine may have combination of shields—“protecting” shield to cover from parasitic wind force and “directing” shield—to make effective part of wind stream circulating inside the space, framed by both above shields, providing maximum take-off of wind-stream capacity.

In some embodiments, the turbines described herein are constructed from more than one unit that can be manufactured in the form of multiple construction blocks.

In some embodiments, the turbines described herein are constructed from more than one unit. Each unit has one or more moveable shield, providing possibility to be adjusted in the most effective way to accept wind stream force, as streams of wind may have different directions in different zone.

In some embodiments, the turbines described herein are equipped with the shield(s) of different size and shape that may have different functions: just shielding; shielding, balancing of the whole construction, redirecting part of wind power to the working part of the turbine; shielding and redirecting the whole wind power to the working part of the turbine; shielding and redirecting of extra wind to the working part of the turbine. In some embodiments shields may generate/provide the effect of stream circulation in space between shields, where blades are rotating, when blades can accept the maximum possible force of a stream.

In some embodiments, the turbines described herein have directing sail to turn turbine shield into the best position to the wind direction by the force of wind stream and/or other mechanism to carry out rotation, including such, which allows to make it in automatic mode.

In some embodiments, the turbines described herein have any form (including cylindric, coniform, but any other form(s) is/are also possible).

In some embodiments, the turbines described herein are shielded from the stream with mobile shield in the part where blades are moving against water stream. In some embodiments shields may generate/provide the effect of wind stream circulation in space between shields, where blades are rotating, when blades can accept the maximum possible force of wind stream. Mobile shield(s) is(are) constantly adjustable to cover from parasitic component of the water stream force and to generate optimal circulation of wind-stream for the maximum take-off of wind-stream-force. The turbine may have one or more blades of any shape and size.

In some aspects, the disclosure describes water turbines using the same principle as the wind turbines described above.

In some embodiments, the water turbines described herein are constructed from more than one unit that can be manufactured in the form of multiple construction blocks, which, when turbine is being assembled, can be added/joined by principle of column crane/tower crane and/or alike method of turbine building up from below.

In some embodiments, the water turbines described herein are constructed from more than one unit, one on top of another. Each unit has its own moveable shield(s), providing possibility to be adjusted in the most effective way to accept water stream force, as water streams may have different directions at different height.

In some embodiments, the water turbines described herein are equipped with the shield(s) of different size and shape that may have different functions: just shielding; shielding, balancing of the whole construction, redirecting part of water power to the working part of the turbine; shielding and redirecting the whole water power to the working part of the turbine; shielding and redirecting of extra water power to the working part of the turbine. In some embodiments shields may generate/provide the effect of stream circulation in space between shields, where blades are rotating, when blades can accept the maximum possible force of a stream.

In some embodiments, the water turbines described herein have directing fin to turn turbine shield or turbine block into the best position to the water direction by the force of water stream and/or other mechanism to carry out rotation, including such, which allows to make it in automatic mode.

In some embodiments, the water turbines described herein have any form (including cylindric, coniform, but any other form(s) is/are also possible).

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIGS. 1A and 1B illustrate an exemplary embodiment of the wind and water turbines described herein, in accordance with some implementations. Part of the turbine that produces only wind/water drag, lowering the efficiency of the turbine, is covered by the adjustable shield, which changes its position depending on wind direction. FIG. 1A illustrates a side view of the described wind and water turbine, in accordance with some implementations. FIG. 1B illustrates a top view of the described wind and water turbine, in accordance with some implementations.

FIGS. 2A and 2B illustrate that the shielded turbine may also have a horizontal axis, in accordance with some implementations. FIG. 2A illustrates a side view of an unshielded turbine, in accordance with some implementations. FIG. 2B illustrates a side view of an unshielded turbine with reference to useful and counter-productive wind components, in accordance with some implementations.

FIGS. 3A, 3B, 3C and 3D illustrate different functions, sizes and shapes of the wind shield, in accordance with some implementations. FIG. 3A illustrates a turbine design with a wind shield configured not to redirect an unproductive wind component to the turbine blades, in accordance with some implementations. FIG. 3B illustrates a turbine design with a wind shield configured to redirect a portion of an unproductive wind component to the turbine blades, in accordance with some implementations. FIG. 3C illustrates a turbine design with a wind shield configured to redirect the entirety of an unproductive wind component to the turbine blades, in accordance with some implementations. FIG. 3D illustrates an alternate turbine design with a wind shield configured to redirect an unproductive wind component to the turbine blades, in accordance with some implementations.

FIGS. 4A, 4B and 4C show turbines united into a turbine block, in accordance with some implementations. FIG. 4A illustrates a dual-turbine design with a wind shield configuration redirecting unproductive components in a divergent fashion, in accordance with some implementations. FIG. 4B illustrates a dual-turbine design with a wind shield configuration redirecting unproductive components in a convergent fashion, in accordance with some implementations. FIG. 4C illustrates an alternative dual-turbine design with a wind shield configuration redirecting unproductive components in a divergent fashion, in accordance with some implementations.

FIGS. 5A, 5B and 5C illustrate different buildings equipped with the proposed wind turbine, in accordance with some implementations.

FIG. 6 illustrates a view from above a vertical-axis wind turbine having two wind shields.

FIG. 7 is a photo of a working model of a vertical-axis wind turbine having two wind shields.

### DETAILED DESCRIPTION

Reference will now be made in detail to implementations of the present application as illustrated in the accompanying drawings. The same reference indicators will be used throughout the drawings and the following detailed description to refer to the same or like parts. Those of ordinary skill in the art will realize that the following detailed description of the present application is illustrative only and is not intended to be in any way limiting. Other embodiments of the present application will readily suggest themselves to such skilled persons having benefit of this disclosure.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

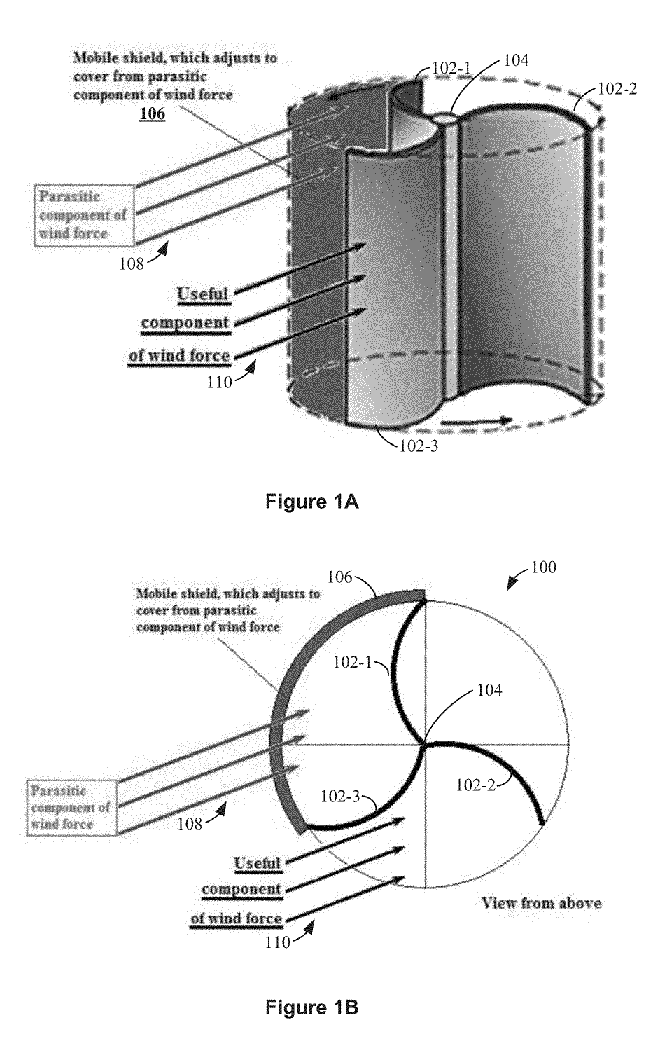

Referring to FIG. 1, in some aspects, the disclosure describes a vertical axis wind turbine, which is shielded from the parasitic component of wind force with mobile shield. Mobile shield is constantly adjustable to cover from parasitic component of wind force. Conventionally, the blades of a wind turbine experience drag, when moving against the wind, which lowers the capacity of the turbine. In the proposed design the part of the turbine, where blades are moving against the wind, is shielded. The shield position is adjustable to the wind direction. This can be done using a simple wind vane, automatically using a wind sensor coupled with a servo motor, or by the operator, and/or in any other way.

Using such construction wind turbine accepts 50% of wind force which is directed to blade/paddle surface of wind turbine and these 50% of accepted force are totally directed for useful work. Parasitic 50% component of wind force is absolutely shielded and does not lower the amount of useful work.

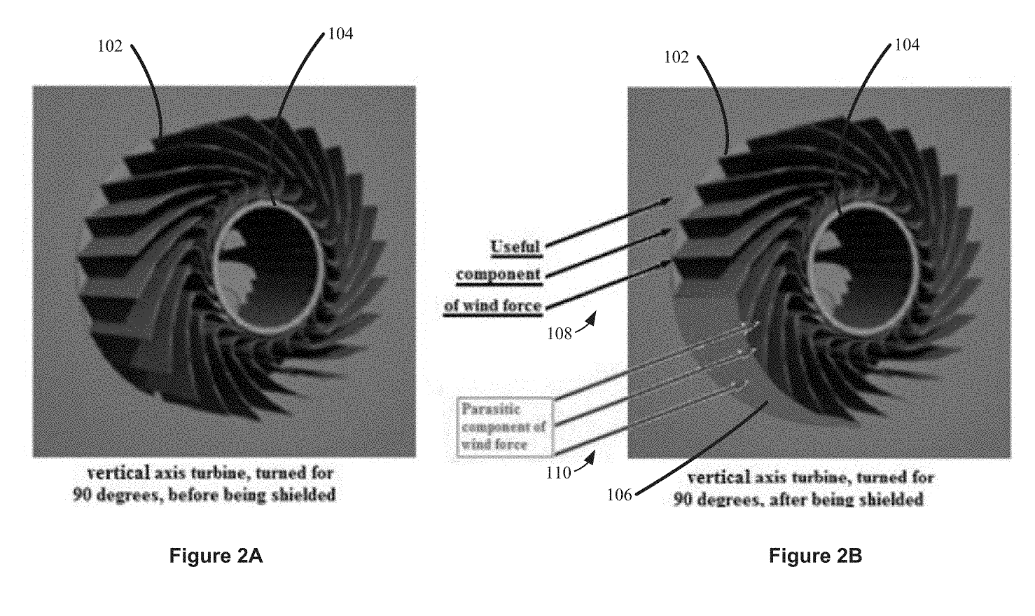

Referring to FIG. 2, though the vertical-axis wind turbine is preferable, horizontal-axis wind turbine using the same principle may be also constructed. Unlike other horizontal axis turbines this turbine will have maximal capacity/ efficacy when its axis oriented perpendicular to the direction of the wind (this will be like a vertical axis turbine turned by) 90°). In this case the shield always covers the part of the turbine where the blades are moving against the wind. The shield may also change its position. This will be very helpful if the wind has substantial vertical component. Like other horizontal-axis wind turbines such turbine must be oriented according to the wind, but their axis should be perpendicular to the direction of the wind to have highest efficacy.

Using such principle we can build either wind turbines or turbines for any water streams power stations.

Turbine can be constructed as single unite or being constructed from more than one unit, what provides possibility to be adjusted in the most effective way to accept wind stream force, as streams of wind (or water) can in some way differ from each other by direction on different height.

Turbine can be constructed as single unit or being constructed from more than one unit (hereinafter also named as turbine and/or wind turbine), but can be manufactured in the form of multiple construction blocks, which, when turbine is being assembled, can be added/joined by principle of column crane/tower crane and/or alike method of turbine building up from below. Such method significantly lowers construction cost on the construction site, because turbine builds itself from below. This also provides independence to the construction process carrying from wind conditions.

In some embodiments, the turbines described herein can be constructed as single unite or it may be a multilevel unit (when it is constructed from more than one unit on top of one another) or can have any form (including cylindric, coniform, but any other form(s) is/are also possible).

Turbine can have any necessary quantity of blades/paddles (one or more). In some embodiments, a turbine includes four blades/paddles, in accordance with one implementation. In other embodiments, the turbine has, 2, 3, 4, 5, 6, 7, 8, 9, 10, or more blades/paddles. The blade(s)/paddle(s) of turbine can have any necessary form/shape.

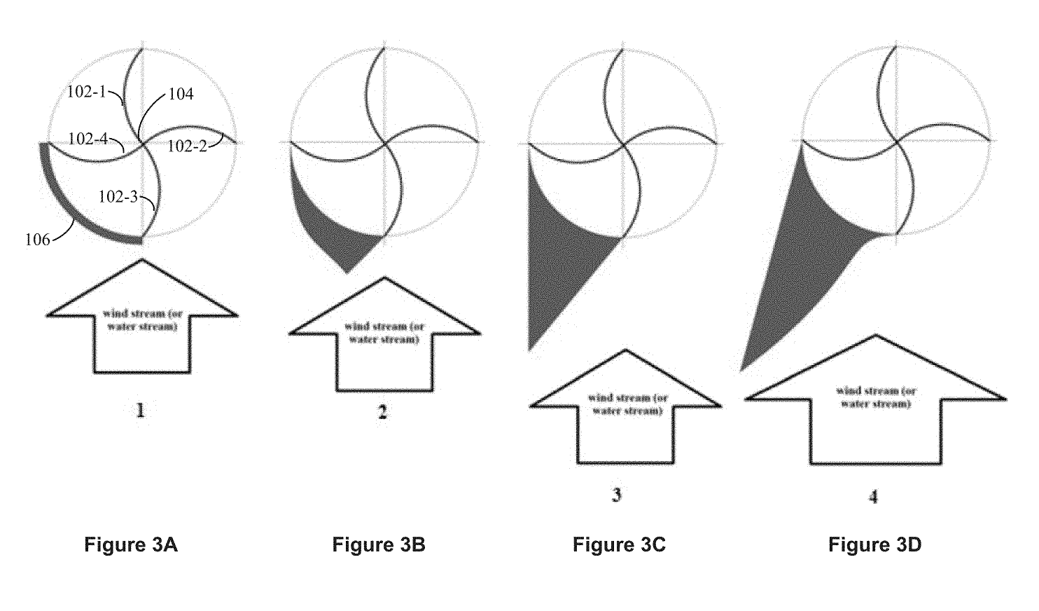

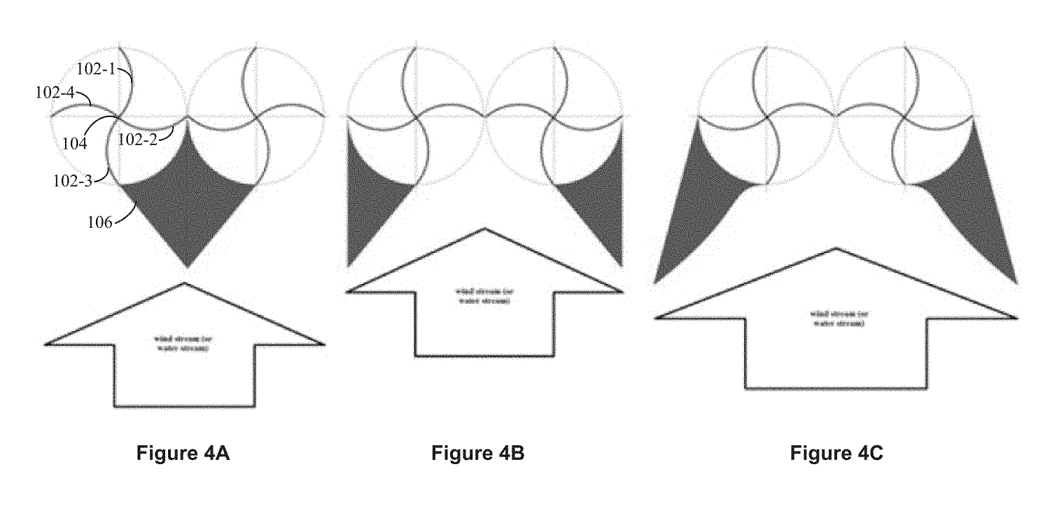

Referring to FIG. 3, the shield(s) of the turbine may cover any necessary surface and/or shield(a) any necessary sector(s). Shield(s) of turbine may only shield the parasitic component of wind force and/or may redirect some/necessary quantity of wind force, making it to fulfill useful work. The shield(s) may have several functions: just shielding (FIGS. 3-1); shielding, balancing of the whole construction, redirecting part of wind power to the working part of the turbine (FIGS. 3-2); shielding and redirecting the whole wind power to the working part of the turbine (FIGS. 3-3); shielding and redirecting of extra wind to the working part of the turbine (FIGS. 3-4). The shield may have different size and shape depending on its function.

Referring to FIG. 4, in some embodiments, turbines (two or more) can be united together (hereinafter turbine block) to collect more from wind stream, but in this case turbine shields may have fixed position and the whole turbine block has to be turned to the wind for adjustment.

In some embodiments, the turbine (or turbine block) can also have directing sail to turn turbine shield or turbine block into the best position to the wind direction by the force of wind stream and/or other mechanism to carry out rotation, including such, which allows to make it in automatic mode.

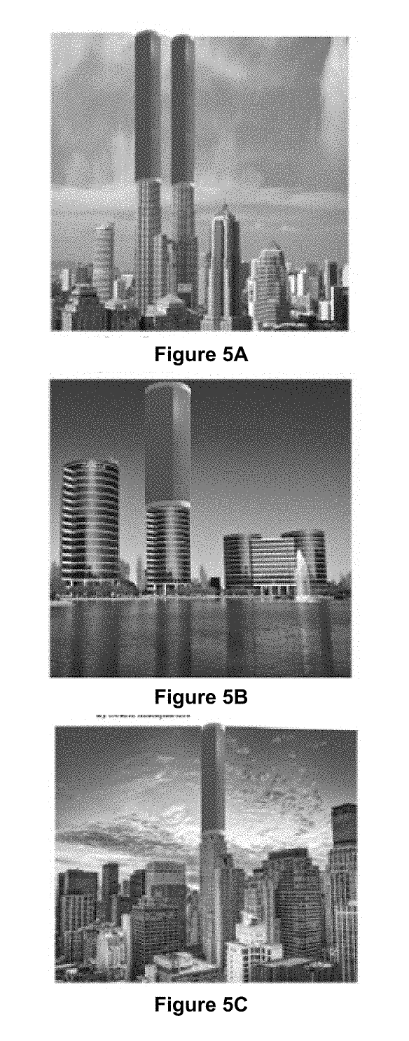

In some embodiments, the turbines described herein are installed on buildings, e.g., skyscrapers, placing it as a top part of the building (but it is also possible to place it in the middle and/or in any other place(s)). FIG. 5 illustrates what some buildings would look like with an installed turbine, in accordance with some implementations.

### EXAMPLES

The main idea of the turbines described herein is to make wind stream circulation to convert bigger portion of mechanical energy of the wind stream into electricity. This idea was developed using the principle which allowed to make revolution in hydro-electricity generation—transferring from water wheel to turbine, where water stream is directed by snail-type pipe and where energy of the stream is absorbed by all the blades of hydro-turbine, which contact with the stream on the distance of more than half-circle of snail-type circling pipe. For conversion of water-stream energy into electricity it gave the increase from approximately 11% to 70-85%. For wind generation it is lower, but also considerable.

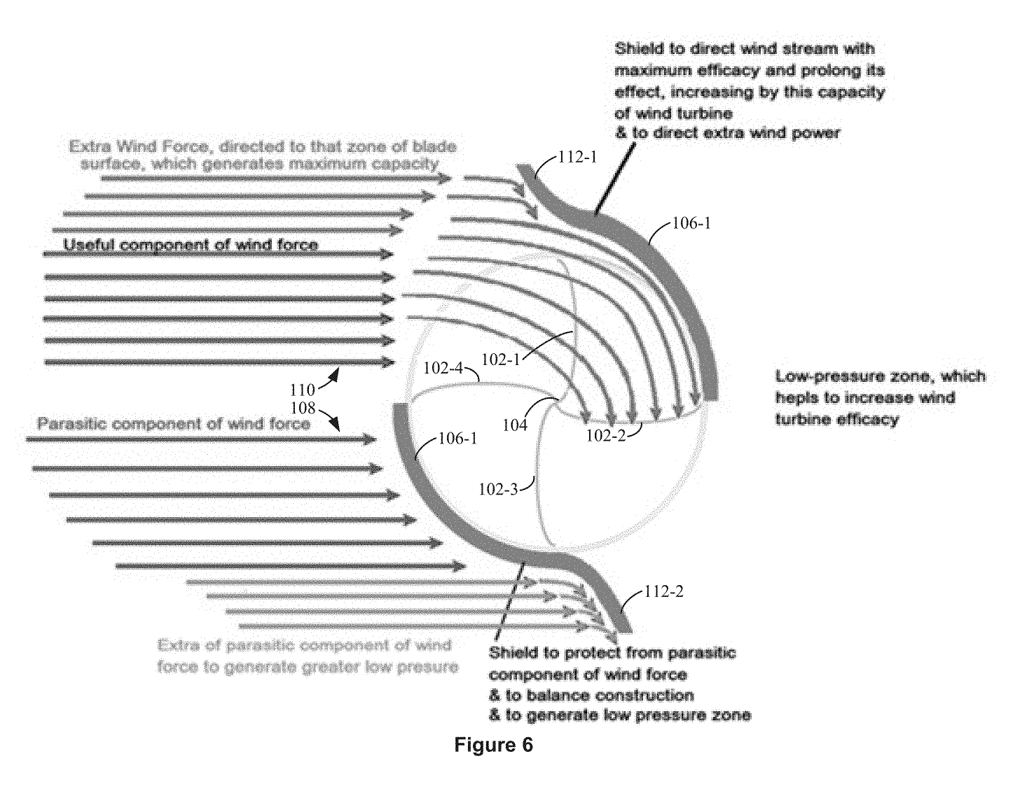

Understanding that circulation of wind stream gives the similar effect and to realize mentioned effect for wind/air stream it was developed the next construction of wind turbine—vertical axis wind turbine, where shields are movable and automatically oriented towards wind stream. FIG. 6 illustrates a view from above a turbine, showing a desired orientation to the wind stream, in accordance with some implementations.

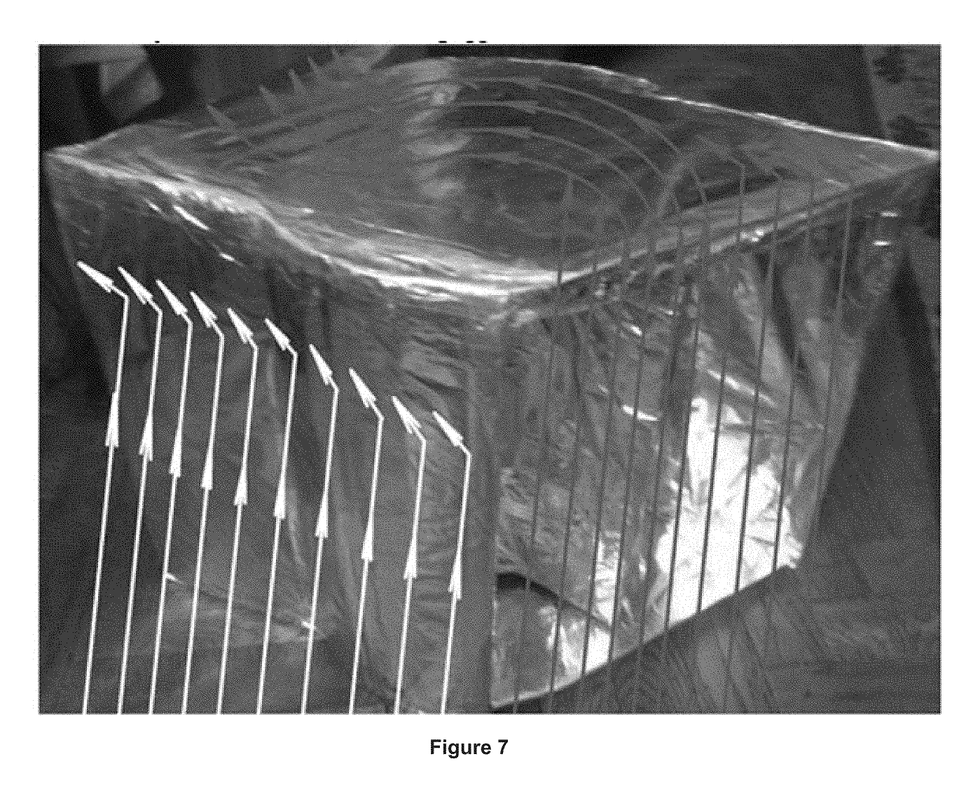

A model of the wind turbine described herein was constructed in order to test qualitative characteristics and effects of the proposed design. It was found that circulation of wind stream allows to the turbine blades to absorb more wind energy, than without circulation. A photo of the constructed model, with arrows showing approximate direction of wind stream and how it circulates, is provided in FIG. 7.

Approximate calculations of wind-turbine capacities. Engineers, calculated the capacity of a vertical-axis wind turbine, as described herein, accounting for the effect of circulation of wind stream, fairing effect and effect of low pressure zone from the side of turbine, opposite to the side of wind-stream-attack. Tables 1-3 present these calculations. In Tables 1-3, assumptions about the height of the turbine are provided (e.g., for installation on top of skyscrapers).

TABLE 1

| Wind Turbine - Height | | WindTurb. Height | |
|---|---|---|---|
| 18 m × Diameter 3.6 m | | 100 m × Diameter 40 m | |
| Wind Speed, | Capacity, | Wind Speed, | Capacity, |
| m/s | kW · h per h | m/s | MW · h per h |
| 5 | 10.26 | 10 | 1.5 |
| 7.5 | 24.3 | 15 | 5.06 |
| 10 | 47.46 | 20 | 12 |
| 12.5 | 82.02 | 22.5 | 17.08 |
| 15 | 130.24 | 25 | 23.44 |
| 17.5 | 194.4 | 27.5 | 31.2 |
| 20 | 276.8 | 30 | 40.5 |
| 22.5 | 379.68 | | |
| 25 | 505.36 | | |
| 27.5 | 656.1 | | |
| 30 | 10.26 | | |

TABLE 2

| Wind Turbine - Height | | WindTurb. - Height | |
|---|---|---|---|
| 26 m × Diameter 4.6 m | | 250 m × Diameter 66 m | |
| Wind Speed, | Capacity, | Wind Speed, | Capacity, |
| m/s | kW · h per h | m/s | MW · h per h |
| 7.5 | 18.92 | 15 | 20.88 |
| 10 | 44.86 | 20 | 49.5 |
| 12.5 | 87.6 | 25 | 96.68 |
| 15 | 151.36 | 27.5 | 128.68 |
| 17.5 | 240.36 | 30 | 167.06 |
| 20 | 358.8 | I cosidered to build | |
| | | this turbine on the top | |
| | | of the hill or on the | |
| | | top of skyscraper, that | |
| | | is why calculated | |
| | | capacity for such high | |
| | | winds | |
| 22.5 | 510.86 | | |
| 25 | 700.78 | | |
| 27.5 | 932.74 | | |
| 30 | 1210.96 | | |

TABLE 3
Wind Turbine - Height 36 m × Diameter 6.6 m

| Wind Speed, m/s | Capacity, kW · h per h |
|---|---|
| 7.5 | 37.58 |
| 10 | 89.1 |
| 12.5 | 174.02 |
| 15 | 300.72 |
| 17.5 | 477.52 |
| 20 | 712.8 |
| 22.5 | 1014.9 |
| 25 | 1392.18 |
| 27.5 | 1853 |
| 30 | 2405.7 |

Development of this wind-turbine construction aimed the next purposes:

To make more effective wind-turbine, which will be able to work effectively either at low or at the highest wind speed (during wind-storm) [for this turbine it is possible, thanks increased absorption of mechanical energy due to wind-stream circulation and because it is possible to decrease the amount of wind-stream by less effective orientation of shields, to protect generator of wind-turbine from extra-load]

To lower construction costs and dependence from wind conditions during construction period—wind turbine of the developed construction can be built from below to the top by the principle of tower crane. All wind-turbines are built in zones with high wind activity, elevation of any object on big height (where winds are stronger) is very complicated, and can be realized only at lowest wind activity, which are usually rear in places with high average wind activity. In case of developed turbine there is no need to elevate something—all the modules can assembled on the ground and assembled together from below, as it is for tower crane. +it is possible to locate cheap magnet-free generators [only with copper coil winding] from below [under the blades' and main magnet-generator modules], which can be used as additional during periods with high wind activity.

To make turbine which may have highest possible capacity (Possibility to protect wind-turbine from extra wind force [1] and building it from below up opens the way to big-scale wind turbines)

To lower the price of wind-electricity generation, first—because such wind turbines can be located on the top of newly constructed buildngs (being incorporated into them), i.e. electricity will be consumed at the same place, where it is generated, making megalopolises energy independent+because it is possible to locate cheap magnet-free generators [only with copper coil winding] from below [under the blades' and main magnet-generator modules], which can be used as additional generator during periods with high wind activity. (Magnet-free generators have lower efficacy, but they are much cheaper and will be able to utilize extra mechanical energy of wind during wind storm, for example)

### Exemplary Embodiments.

In one aspect, the disclosure describes A Savonius vertical-axis wind turbine (e.g., turbine 100 illustrated in the figures), comprising: a shaft (e.g., shaft 104 illustrated in the figures) configured to rotate about a first axis; a plurality of aerofoil blades (e.g., blades 102 illustrated in the figures) transversely mounted with respect to the first axis, on the shaft, each respective aerofoil blade in the plurality of aerofoil blades transversely extending outwards from the shaft to a first distance from the shaft; a generator coupled to the shaft, the generator configured to generate electricity from rotational energy of the shaft when the shaft rotates about the axis; and a first curved wind shield (e.g., wind shield 106 illustrated in the figures) comprising a semi-circular shape defined by a first curvature. Each point of the first curvature is a fixed second transverse distance from the shaft. The fixed second transverse distance is greater than the first distance. The first curved wind shield is transversely positioned at the fixed second transverse distance away from the rotating shaft. The first curved wind shield is rotatable about the rotating shaft, at the fixed second transverse distance, along the first curvature.

In some embodiments, the first curved wind shield further includes an extension (e.g., extension 112 illustrated in the figures) on a first side of the first curved wind shield substantially parallel to the first axis (e.g., on a side that is oriented most parallel to the first axis), the extension protruding away from the shaft (e.g., the extension is defined by a third curvature oriented oppositely from the first curvature, relative to the axis). In some embodiments, one or more wind shields have an extension on both sides that are substantially parallel to the axis/shaft, to orient the wind shields relative to the direction of incoming wind.

In some embodiments, the fixed transverse distance (e.g., of the shield from the shaft/axis) is no more than 66% greater than the first distance (e.g., the distance between the furthest position of the blades and the shaft/axis). In some embodiments, the fixed transverse distance is no more than 50% greater than the first distance. In some embodiments, the fixed transverse distance is no more than 33% greater than the first distance. In some embodiments, the fixed transverse distance is no more than 25% greater than the first distance. In some embodiments, the fixed transverse distance is no more than 10% greater than the first distance. In some embodiments, the fixed transverse distance is no more than 5% greater than the first distance.

In some embodiments, the wind turbine also includes a second curved wind shield comprising a semi-circular shape defined by a second curvature. In some embodiments, the second curved wind shield has a same shape as the first wind shield, covering the same or smaller, same or bigger sector. Each point of the second curvature is a fixed third transverse distance from the shaft (e.g., in some embodiments, the second curved wind shield has a same curvature as the first wind shield and is positioned at a same fixed transverse distance from the shaft as the first wind shield). The fixed third transverse distance is greater than the first distance. The second curved wind shield is transversely positioned at the fixed third transverse distance away from the rotating shaft. The second curved wind shield is rotatable about the rotating shaft, at the fixed third transverse distance, along the second curvature. The second curved wind shield is rotationally positioned at a first fixed angle (e.g., 180 degrees) from the first curved wind shield, relative to the first axis. The second curve wind shield is configured to rotate about the rotating shaft at the first fixed angle from the first curved wind shield, relative to the first axis.

In some embodiments, the second curved wind shield is rotationally positioned 180±60 degrees from the first wind shield, relative to the first axis. In some embodiments, the second curved wind shield is rotationally positioned 180 degrees from the first wind shield, relative to the first axis. In some embodiments are fixed on the same rotatable platform, covering any certain sectors, being position in any certain way in the attitude to each other.

In some embodiments, the first curved wind shield further comprises a first extension on a first side of the first curved wind shield parallel to the first axis, the extension protruding away from the shaft, and the second curved wind shield further comprises a second extension on a first side of the second wind shield parallel to the first axis, the extension protruding away from the shaft. The first side of the first curved wind shield is a same side, relative to a rotational position about the rotating shaft, as the first side of the second curved wind shield (e.g., the first extension and the second extension are positioned on a same leading or lagging edge of the wind shield, relative to a first rotational direction about the first axis).

In some embodiments, the wind turbine also includes a sail mounted in a fixed position relative to the first wind shield, wherein the fixed position of the sail is configured to rotate the first wind shield, when pushed by wind having a first directional vector, to a position shielding the plurality of aerofoil blades from counter-productive forces of the wind (e.g., counter-productive wind 108 illustrated in the figures, as opposed to productive wind 110 illustrated in the figures) having the first directional vector. In some embodiments, the wind turbine has mechanism for automatic positioning of shield(s) in the attitude to wind turbine blades.

In some embodiments, the wind turbine also includes a motor in mechanical communication with the first wind shield and an electronic device in electronic communication with the motor. The electronic device including one or more processors and a memory, the memory storing instructions that, when executed by the one or more processors, cause the wind turbine to determine a first directional vector of a wind and position the first wind shield, using the motor in mechanical communication with the first wind shield, to shield the plurality of aerofoil blades from counterproductive forces of the wind having the first directional vector.

In some embodiments, the wind turbine also includes a wind sensor (e.g.., mounted on top of or nearby the turbine) in electronic communication with the electronic device, the wind sensor configured to determine the first directional vector of the wind (e.g., wind hitting the turbine), and communicate the first directional vector of the wind to the electronic device (e.g., to cause the first and/or second wind shield to be moved to better shield the blades of the turbine from a counter-productive wind force).

In some embodiments, the wind turbine is mounted on the top of a building.

In some aspects, the disclosure describes a method for generating electricity, comprising operating a Savonius vertical-axis wind turbine as described herein.

In some embodiments, the wind turbine is mounted on the top of a first building, and electricity generated by the wind turbine used to power the first building.

### Concluding Remarks

It will be understood that, although the terms “first,” “second,” etc. may be used herein to describe various elements, these elements should not be limited by these terms. These terms are only used to distinguish one element from another. For example, a first object could be termed a second object, and, similarly, a second object could be termed a first object, without changing the meaning of the description, so long as all occurrences of the “first object” are renamed consistently and all occurrences of the “second object” are renamed consistently. The first object and the second object are both objects, but they are not the same object.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included exemplary systems, methods, and apparatuses that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A Savonius vertical-axis wind turbine, comprising:
a shaft configured to rotate about a first axis;
a plurality of aerofoil blades transversely mounted with respect to the first axis, on the shaft, each respective aerofoil blade in the plurality of aerofoil blades transversely extending outwards from the shaft to a first distance from the shaft;
a generator coupled to the shaft, the generator configured to generate electricity from rotational energy of the shaft when the shaft rotates about the axis; and
a first curved wind shield comprising a semi-circular shape defined by a first curvature, wherein:
each point of the first curvature is a fixed second transverse distance from the shaft,
the fixed second transverse distance is greater than the first distance,
the first curved wind shield is transversely positioned at the fixed second transverse distance away from the rotating shaft, and
the first curved wind shield is rotatable about the rotating shaft, at the fixed second transverse distance, along the first curvature.

2. The Savonius vertical-axis wind turbine of claim 1, wherein the first curved wind shield further comprises an extension on a first side of the first curved wind shield substantially parallel to the first axis, the extension protruding away from the shaft.

3. The Savonius vertical-axis wind turbine of claim 1, wherein the fixed transverse distance is no more than 66% greater than the first distance.

4. The Savonius vertical-axis wind turbine of claim 1, further comprising:
a second curved wind shield comprising a semi-circular shape defined by a second curvature, wherein:
each point of the second curvature is a fixed third transverse distance from the shaft,
the fixed third transverse distance is greater than the first distance,
the second curved wind shield is transversely positioned at the fixed third transverse distance away from the rotating shaft,
the second curved wind shield is rotatable about the rotating shaft, at the fixed third transverse distance, along the second curvature,
the second curved wind shield is rotationally positioned at a first fixed angle from the first curved wind shield, relative to the first axis, and
the second curve wind shield is configured to rotate about the rotating shaft at the first fixed angle from the first curved wind shield, relative to the first axis.

5. The Savonius vertical-axis wind turbine of claim 4, wherein the second curved wind shield is rotationally positioned 180±60 degrees from the first wind shield, relative to the first axis.

6. The Savonius vertical-axis wind turbine of claim 4, wherein:
the first curved wind shield further comprises a first extension on a first side of the first curved wind shield substantially parallel to the first axis, the extension protruding away from the shaft, and
the second curved wind shield further comprises a second extension on a first side of the second wind shield parallel to the first axis, the extension protruding away from the shaft, wherein:
the first side of the first curved wind shield is a same side, relative to a rotational position about the rotating shaft, as the first side of the second curved wind shield.

7. The Savonius vertical-axis wind turbine of claim 1, further comprising a sail mounted in a fixed position relative to the first wind shield, wherein the fixed position of the sail is configured to rotate the first wind shield, when pushed by wind having a first directional vector, to a position shielding the plurality of aerofoil blades from counter-productive forces of the wind having the first directional vector.

8. The Savonius vertical-axis wind turbine of claim 4, further comprising a sail mounted in a fixed position relative to the first wind shield, wherein the fixed position of the sail is configured to rotate the first wind shield, when pushed by wind having a first directional vector, to a position shielding the plurality of aerofoil blades from counter-productive forces of the wind having the first directional vector.

9. The Savonius vertical-axis wind turbine of claim 1, further comprising:
a motor in mechanical communication with the first wind shield; and
an electronic device in electronic communication with the motor, the electronic device including one or more processors and a memory, the memory storing instructions that, when executed by the one or more processors, cause the wind turbine to:
determine a first directional vector of a wind; and
position the first wind shield, using the motor in mechanical communication with the first wind shield, to shield the plurality of aerofoil blades from counterproductive forces of the wind having the first directional vector.

10. The Savonius vertical-axis wind turbine of claim 9, further comprising:
a wind sensor in electronic communication with the electronic device, the wind sensor configured to:
determine the first directional vector of the wind; and
communicate the first directional vector of the wind to the electronic device.

11. The Savonius vertical-axis wind turbine of claim 4, further comprising:
a motor in mechanical communication with the first wind shield; and
an electronic device in electronic communication with the motor, the electronic device including one or more processors and a memory, the memory storing instructions that, when executed by the one or more processors, cause the wind turbine to:
determine a first directional vector of a wind; and
position the first wind shield, using the motor in mechanical communication with the first wind shield, to shield the plurality of aerofoil blades from counterproductive forces of the wind having the first directional vector.

12. The Savonius vertical-axis wind turbine of claim 11, further comprising:
a wind sensor in electronic communication with the electronic device, the wind sensor configured to:
determine the first directional vector of the wind; and
communicate the first directional vector of the wind to the electronic device.

13. The Savonius vertical-axis wind turbine of claim 1, wherein the wind turbine is mounted on the top of a building.

14. A method for generating electricity, comprising operating a Savonius vertical-axis wind turbine according to claim 1.

15. The method for generating electricity of claim 14, wherein:
the wind turbine is mounted on the top of a first building, and
electricity generated by the wind turbine used to power the first building.
